(19) United States
(12) Patent Application Publication
(10) Pub. No.: US 2002/0194028 A1
(43) Pub. Date: Dec. 19, 2002

(54) Method, apparatus, and readable medium for on-line patient evaluation

(76) Inventors: James A. Johnston, Pittsburgh, PA (US); Michael Strnisha, Canonsburg, PA (US); James Gogal, Moon Township, PA (US); Chester A. Phillips III, McDonald, PA (US)

Correspondence Address: PHILIPS ELECTRONICS NORTH AMERICAN, 580 WHITE PLAINS ROAD, TARRYTOWN, NY, 10591, US

(21) Appl. No.: 09/879,993

(22) Filed: Jun. 14, 2001

(51) Int. Cl. G06F 17/60

(52) U.S. Cl. 705/3

(57) ABSTRACT

A method, apparatus, and readable medium for presenting an Internet or Intranet accessible patient evaluation system. Medical evaluation forms are presented to users over a transmission channel such that a user at a browser may access previously prepared forms of patients, editing those forms, or enter evaluation data for a new patient. A generator uses form data stored in a configuration database to generate HTML/ASP page documents in which users can view previously entered data or add new data. The interaction between the generator and a configuration module containing the loaded configuration database is dynamic, as when the configuration database changes or is updated the generator is caused to generate new HTML/ASP page documents to correspond to the changed configuration database.

### BACKGROUND OF THE INVENTION

1. Field of the Invention

The present invention relates to a method, apparatus, and readable medium for presenting an Internet or Intranet accessible patient evaluation system. More particularly, the present invention relates to a method, apparatus, and readable medium for presenting an Internet or Intranet accessible patient record viewing and editing system using HTML/ASP documents.

2. Description of the Related Art

In the medical environment, it is very important to perform evaluations of patients before and after surgeries. These evaluations allow doctors and medical staff to know particularities of individual patients and to take those particularities into account in preparing for and performing surgery, as well as following up after the surgery has been performed. Typically, these particularities are very important to anesthesiologists who have to take all the particularities into account when administering anesthesia. Previous patient evaluation systems allowed for entry of data for a patient, review of that data by authorized personal, and editing and adding of additional data in a closed network environment. For example, a doctor would typically ask a patient a series of questions about their health, for example, and thereafter enter the answers into the patient evaluation system at a computer at the doctors office. However, these patient evaluation systems typically would require that each computer have installed thereon patient evaluation software, which would require the computers to be sufficiently powerful, have large amounts of free media storage space, and large amounts of free memory. The overall costs of such powerful computers are a burden on the doctors, practices, and hospitals that need to utilize such patient evaluation systems. In addition, as each doctor, practice, or hospital changes standards and configurations regarding what an evaluation consists, for example, each powerful computer must individually be upgraded with new software or media. Further problems include preventing medical personal from entering, viewing, or editing patient evaluation information from convenient locations, such as from their homes. Lastly, such an individualized patient evaluation system prevents a patient from entering the data by themselves from similarly convenient locations. Therefore, it was determined that a different approach would be necessary, i.e., one that did not require such powerful computers or individualized installations, and which would allow for access to the patient evaluation system from convenient locations.

In recent years there has been an influx of information available to the general public through the Internet. Any person with access to a computer connected to the Internet can perform searches forvarious illnesses and do research on the same. In a similar fashion, Dr. Mike Roizen of the University of Chicago also presented the public with a page on the Internet where a person could perform a type of self-evaluation. In Dr. Roizen's self-evaluation system, members of the public would answer previously prepared questions presented on a static Internet page. A scoring system would use these answers and generate a score indicating how ill or how healthy an individual was. The Internet pages developed by Dr. Roizen were static Internet pages as they were not able to change dynamically upon a change in the prepared questions. A operator would have to re-create the Internet page and include the new prepared questions. Dr. Roizen also published a grid of what laboratory tests should be done under certain conditions. The self-evaluation system of Dr. Roizen was also promoted as a centralized solution where the public could perform a self-evaluation from the convenience of their homes using low cost computers. All that was needed was an Internet connection and a browser for viewing pages downloaded from Dr. Roizen's Internet page. Dr. Roizen's self-evaluation system was not widely accepted, as typically there is no standard for what elements of an evaluation are necessary or pertinent. Doctors, practices, and hospitals usually generate their own proprietary patient evaluation configurations, with each configuration indicating what questions are necessary and how to interpret the same in evaluating a patient. Thus, although Dr. Roizen set forth a type of centralized solution, the single configuration patient evaluation utilized by Dr. Roizen would not be acceptable for most doctors, practices, or hospitals.

Therefore, what is needed is a patient evaluation system allowing for individualized patient evaluation configurations, a centralized hierarchy so large computer resources are not necessary at a users end, for allowing authorized users to enter new patient data, edit and view existing patient data, and for allowing searching for patient data within available databases.

### SUMMARY OF THE INVENTION

An embodiment of the present invention is directed to an Internet or Intranet accessible patient record viewing and editing system using HTML/ASP documents

An additional embodiment of the present invention is directed to a patient evaluation apparatus, having a configuration module including a configuration database of form data for a medical evaluation form, a dynamic generator to create a marked up document based upon the form data, and a transmitting module to combine the marked up document with medical data of a patient and transmitting the combined marked up document through a transmission channel, such that a user having a browser is capable of receiving and displaying the combined marked up document.

A further embodiment of the present invention is directed to a patient evaluation method, including dynamically creating a marked up document based on a configuration database, with the configuration database including form data for medical evaluation forms, combining the marked up document with medical data of a patient, and transmitting the combined marked up document through a transmission channel to a user having a browser capable of receiving and displaying the received marked up document.

Another embodiment of the present invention is directed to a patient evaluation method, including dynamically creating a marked up document based on a configuration database, with the configuration database including form data for medical evaluation forms, transmitting the marked up document through a transmission channel to a user having a browser capable of receiving and displaying the received marked up document, monitoring for a user addition of medical data to the received marked up document, storing the medical data, and transmitting a combination of the stored medical data and the marked up document through the transmission channel to the user.

Another embodiment of the present invention is directed to a readable medium, for use in a computational device, having a program causing the computational device to dynamically create a marked up document based on a configuration database, with the configuration database including form data for medical evaluation forms, combine the marked up document with medical data of a patient, and transmit the combined marked up document through a transmission channel to a user having a browser capable of receiving and displaying the received marked up document.

An embodiment of the present invention further directed to a readable medium, for use in a computational device, having a program causing the computational device to dynamically create a marked up document based on a configuration database, with the configuration database including form data for medical evaluation forms, transmit the marked up document through a transmission channel to a user having a browser capable of receiving and displaying the received marked up document, monitor for a user addition of medical data to the received marked up document, store the medical data, and transmit a combination of the stored medical data and the marked up document through the transmission channel to the user.

### BRIEF DESCRIPTION OF THE DRAWINGS

Advantages of the invention will become apparent and more readily appreciated for the following description of the preferred embodiments, taken in conjunction with the accompanying drawings of which:

FIG. 1 illustrates a general system overview for an embodiment of the present invention;

FIG. 2 is a flow chart illustrating a method embodiment of the present invention; and

FIG. 3 is a diagram illustrating an implementation of applicants' patient evaluation system.

### DETAILED DESCRIPTION

Reference will now be made in detail to the preferred embodiments, examples of which are illustrated in the accompanying drawings. In accordance with the preferred embodiments, there is provided a method, apparatus, and readable medium for implementing a patient evaluation system through Internet or Intranet based pages.

Embodiments of the present invention will now be set forth herein as being based on Internet or Intranet pages, and specifically utilizing HTML/ASP page documents. HTML is a standard Internet and Intranet marked up page document format, having HTML codes, allowing for easy viewing by users connected to an Internet or Intranet, using a browser for viewing of the HTML page document. A HTML/ASP page document is an active server page and includes, in addition to HTML code, additional visual basic scripts or java scripts. However, although only HTML/ASP page documents and the use of the Internet or Intranets will be set forth herein, as improvements in communication services occur, the present patient evaluation system would be equally applicable to non-HTML/ASP page documents and mechanisms which allow for their delivery to users. Likewise, the present patient evaluation system would equally be applicable to wireless systems providing communication between the user and a location housing the actual patient evaluation software or databases.

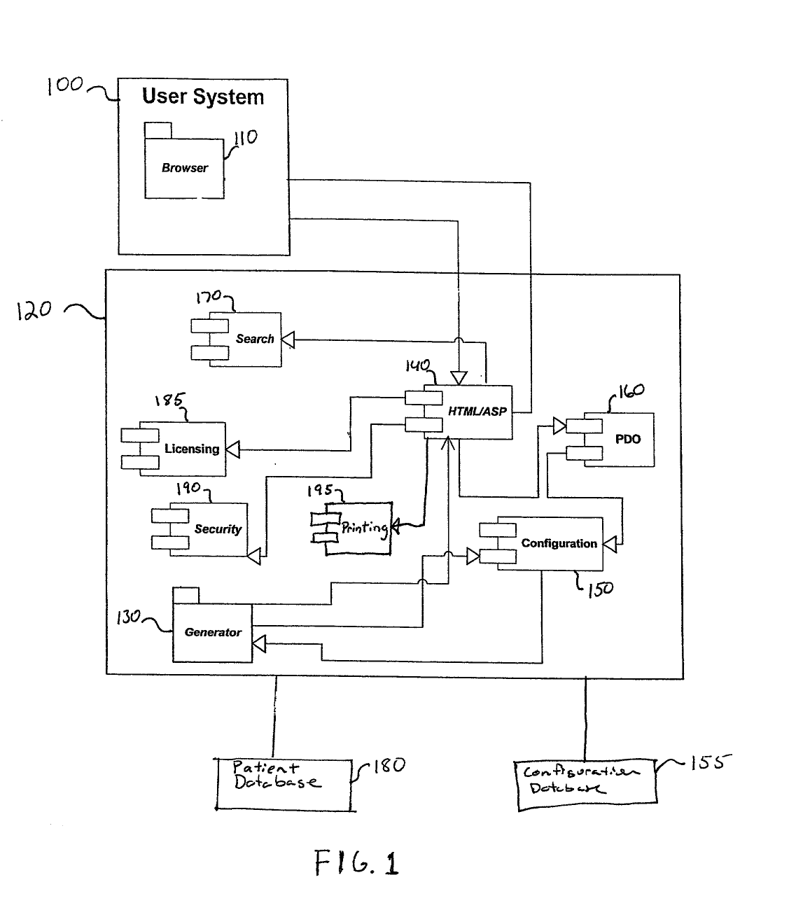

FIG. 1 illustrates a general system overview for an embodiment of the present invention. FIG. 1 illustrates a user system 100, which may be any Internet or Intranet enabled device such as a computer having a modem or any Internet or Intranet access capability. The Internet or Intranet enabled device may also include more simple devices such as network terminals only having Internet or Intranet transmission capability, web-enabled mobile devices, such as personal data assistants (PDAs), or even potentially gaming consoles. Preferably, the transmission channel between user system 100 and a patient evaluation unit 120 would be a secure connection, such as 64 bit encryption internationally or 128 bit encryption within the United States, though this is not necessary. As illustrated in FIG. 1, a browser 110 or similar HTML/ASP page document viewing mechanism allows a user to access HTML/ASP page documents available to a HTML/ASP module 140 through any typical browser-server interaction methodology.

In addition, the user system 100 may be located at a doctor's office, a practice, a hospital, a home of one of the corresponding healthcare workers, or even at a location of a patient. In an embodiment of the present invention a patient may logon and view HTML/ASP page documents and add additional data thereto. HTML/ASP page documents may also include scheduling information, and an embodiment of the present invention may limit a patient to access only that information. Alternatively, only healthcare workers may have access to patient evaluation unit 120.

Patient evaluation unit 120 may be embodied in any type of computational device with sufficient memory and storage resources for implementing the present invention. The transmission channel between user system 100 and patient evaluation unit 120 may be of any type that allows for Internet or Intranet related transmissions between user system 100 and patient evaluation unit 120. Incorporated within patient evaluation unit 120 are multiple modules for implementing the present invention. The modules include, aforementioned HTML/ASP module 140, a patient data object 160, a configuration module 150, a page generator 130, a search module 170, a licensing module 185, a security module 190, and a print services module 195. In addition, patient evaluation unit 120 may also be able to access a patient database 180, or patient database 180 may be included within patient evaluation unit 120. Patient database 180 would include all relevant evaluation information for a patient, including previous surgeries, data for forms previously filled out, personal information such as telephone numbers and addresses, and potentially scheduling information regarding when a test or surgery is scheduled or was performed. Lastly, although these modules have been illustrated as being all incorporated within a single unit, that is not necessary.

Briefly, in an embodiment of the present invention, patient evaluation unit 120 operates in the following manner: a computational device including patient evaluation unit 120 may perform a boot operation, after which a configuration may be loaded from configuration database 155 into memory in configuration module 150, page generator 130 may dynamically create HTML/ASP page documents for use by HTML/ASP module 140. Thereafter, a user may access patient evaluation unit 120 through user system 100 and browser 110, and thereby attempt to download a first HTML/ASP page document from HTML/ASP module 140. Prior to or upon receipt of the first HTML/ASP page document, licensing module 185 may determine whether there are sufficient available licenses available and then the user may be required to enter a security code or login information, as controlled by security module 190. Within the first HTML/ASP page document downloaded to browser 110 would be a number of activatable items for performing certain operations, such as logging off or printing a page through printing module 195, and a number of items activatable to load additional pages. For example, a first activatable item in the first HTML/ASP page document may be a patient admission listing, wherein an activation thereof will cause a new HTML/ASP page document to be loaded corresponding to a patient admission form. These HTML/ASP page documents beyond the first general listing could correspond to forms to be filled in by a patient or medical personal. For example, a form to be filled in may ask a series of questions such as whether the patient smokes and how much, or ask for the gender of the patient.

Upon receipt of the first HTML/ASP page document the user may perform a search of patient database 180 through search module 170, wherein previously filled-in forms for a patient have been stored. The user may also indicate that a new patient is to be added to the patient evaluation system. If a new patient is being added, then patient data object 160 may begin to store all newly added information about the patient as forms from different HTML/ASP page documents are filled-in. If the patient already exists in patient database 180, then patient data object 160 may load all previously filled-in data. For example, a user may enter a patient's name, or sufficient information to identify a patient in patient database 180, and patient data object 160 may then load previously filled-in data, and the user could view the filled-in data within each HTML/ASP page document. Thus, a user can enter a new patient and fill out a series of HTML/ASP page documents having forms therein, alter previously stored patient data, or view the data by viewing the corresponding HTML/ASP page document.

A more detailed operation of each module within patient evaluation unit 120 will now be set forth below.

Generator 130 performs a dynamic code generating operation, whereby form data is retrieved from configuration module 150, and each HTML/ASP page document may be generated based thereon. Generator 130 may perform data display and data configuration. The data display is the visual representation of the data, i.e., color, size, and screen placement. The configuration of data is how the information is programmatically created. For example, activatable buttons (configuration of data) may be created in a HTML/ASP page document with corresponding text adjacent thereto in a specific location (data display). In addition, generator 130 may also perform the coding operation of generating code for visual basic scripts or java scripts to be included within the HTML/ASP page document. The generated HTML/ASP page document appears to a user as a form to be either filled-in, altered, or merely viewed. As noted above, the data display function of generator 130 allows for different colors to be assigned to created items. For example, when data is changed or pre-provided, the created items may appear in different colors. The generated HTML/ASP page document may also appear to a user as a digital representation of a real world paper based form. Generator 130 dynamically interacts with configuration module 150, from which generator 130 retrieves the form data for creating of HTML/ASP page documents.

In an embodiment of the present invention configuration module 150 may be a COM (Component Object Model) object that is designed to access items in configuration database 155. After initial validation of configuration database 155, configuration module 150 may load the configuration, including form data, into memory, with the form data typically remaining in memory so that configuration data may be repeatedly accessed without the necessity of accessing configuration database 155. After loading of the configuration, configuration module 150 will call generator 130 with individual form IDs along with a file path for the HTML/ASP page document to be created by generator 130. As noted above, this process for generating the HTML/ASP page documents may be repeated until all the HTML/ASP page documents are generated and stored for access by HTML/ASP module 140. Configuration module 150 may also check at either predetermined intervals, specified times, to see if configurations have changed in configuration database 155. If changes have occurred, the configuration module 150 may then again call generator 130 to update the created HTML/ASP page documents.

As noted above, doctors, practices, and hospitals typically define their own individualized patient evaluation standards, e.g., what questions are to be asked. These doctors, practices, and hospitals probably all have their own forms that have been developed over time and for which most of their healthcare workers have become accustomed. Configuration database 155 may include all the relevant information for generator 130 to create HTML/ASP page documents that resemble these individualized forms. Therefore, the present invention is easily utilized in any environment, as the preexisting forms of a doctor, practice, or hospital can be converted into a individualized configuration database, for use in the present invention. In addition, as noted above, configurations may change as each doctor, practice, or hospital makes changes in their forms, which would thereby necessitate a change in HTML/ASP page documents. This change in the HTML/ASP page documents can be easily performed by merely changing configuration database 155 according to the updated forms.

Configuration database 155 includes multiple tables that include form ID numbers, with each ID number indicating which form a table corresponds to. A HTML/ASP page document corresponds to a related form ID number in a listL table entry indicating, in order, items that belong on that page. Each item listed in the listL table may be of differing types. For example, an item may be of a free text type, which would indicate to generator 130 to create within that HTML/ASP page document a free text box, in which a user can enter data. For example, a name of a patient may be of a free text box type, as a user will type in that name. Alternatively, the item could be of a list type, which would indicate to generator 130 to generate a list for a user to chose from the list. For example, the item may be labeled “smoker” and of a list type also indicating that a detail box should be displayed also. In this situation, generator 130 would put the text “smoker” in the HTML/ASP page document and place the list adjacent thereto, and a detail box could pop up detailing what each element in the list means, e.g., a heavy smoker may be defined as having more that two packs a day. The item type may also be of a combo type indicating that a single item is made up of multiple items. For example, combo type item may be made up of several items, one being a single select, which would indicate to generator 130 to place the appropriate label next to a HTML radio button, such that a user only has to click on the button in the HTML/ASP page document to make the selection. One of the combo type items may be of a multiple select type, which would correspond to a HTML check box. Typically, each item has a text associated therewith, which generator 130 places in the HTML/ASP page document next to the created HTML radio button or check box, for example. Additionally, there may be multiple layers of items, such that by answering a question a certain way will bring up a dialog box or additional questions. Additional item types may include, but is not limited to, date type, boolean type, numeric type, medication type, allergen type, and test type. Generator 130 can navigate through the tables of the loaded configuration database 155, go through each item on a listL table for a HTML/ASP page document, and create a complete page. Thereafter, generator 130 creates a HTML/ASP page document for the next form listed in a table of the loaded configuration table 155, and repeats this process until all HTML/ASP page documents have been created.

Returning to FIG. 1, upon the start of a user session with patient evaluation unit 120, patient data object 160 is created. Patient data object 160 performs several different operations in patient evaluation unit 120. First, patient data object 160 may perform reading and writing operations to patient database 180, which includes data added from other available databases such as an Admissions, Discharges and Transfers (ADT) system database. Second, patient data object 160 may distinguish between user entered data and pre-existing data. And third, patient data object 160 may be capable of determining the minimum patient information needed for database storage. Typically, upon finishing an updating of a patient's forms the user will activate a log-out operation, at which time patient data object 160 will store the updated data to patient database 180. However, if there is insufficient data entered in the HTML/ASP page documents, then patient data object 160 should not store the same in patient database 180. Insufficient data would correspond to there not being enough data to uniquely identify a patient for later data retrieval. While, if there is some type of disconnection between user system 100 and patient evaluation unit 120 or if patient data object 160 timed out from inactivity, patient data object 160 may store the partial filled-in data in patient database 180 for later completion of the patient data update.

Search module 170, as illustrated in FIG. 1, functions to allow a user to perform searches of patient database 180 for either patients and/or case data performed by the user. These general functions of search module 170 include providing the ability to search for patients given a set of identifying information, determining a percentage match value for patient searches, provide the ability to search for cases given an internal patient identifier, and provide the ability to search for cases given a set of general search criteria. In an embodiment of the present invention, search module 170 may be a COM (Component Object Model) object, and may be created each time a user starts a user session with patient evaluation unit 120, upon the first submission of search information. Typically, generator 130 creates an area on the HTML/ASP page document for entry of search parameters and search initiation, and a user may enter the corresponding search request therein. Search parameters may include, but are not limited to, patient's name, their medical record number, their birth date, the evaluation date, and their national ID number, e.g., social security number.

The remaining licensing (185), security (190), and printing (195) modules illustrated in FIG. 1, will now be discussed herein. Licensing module 185 determines whether the number of users from an individual doctor, practice, or hospital has exceeded the number of purchased licensed. For example, if a practice only has 5 licenses then no more than 5 users may be logged on from that practice. Alternatively, the patient evaluation system could be set up to allow an unlimited amount of users to utilize the patient evaluation system, and keep track of each user to later tally up the number of uses and corresponding costs to the user. Further, security module 190 may control what services are available to a user, e.g., allowing only viewing of HTML/ASP page documents or both viewing and editing. Security module 170 also performs the logging in and verification of user identity. And printing module 195 prepares a HTML/ASP page document for printing. To preserve the privacy of patients, an embodiment of the present invention attempts to prevent a user from saving a HTML/ASP page document to a storage unit available to user system 100. To accomplish this, upon a print command, printing module 195 looks up the patient, generates a bit map image of the corresponding HTML/ASP page document, causes the bit map image to be converted to a Portable Networks Graphics (PNG) image, displays the PNG image on browser 110 and causes the browser to automatically bring up the print dialog and print out the PNG image of the HTML/ASP page document. Alternative methods of printing may be available, and if deemed necessary, the HTML/ASP page document could be stored on the local storage unit of user system 100.

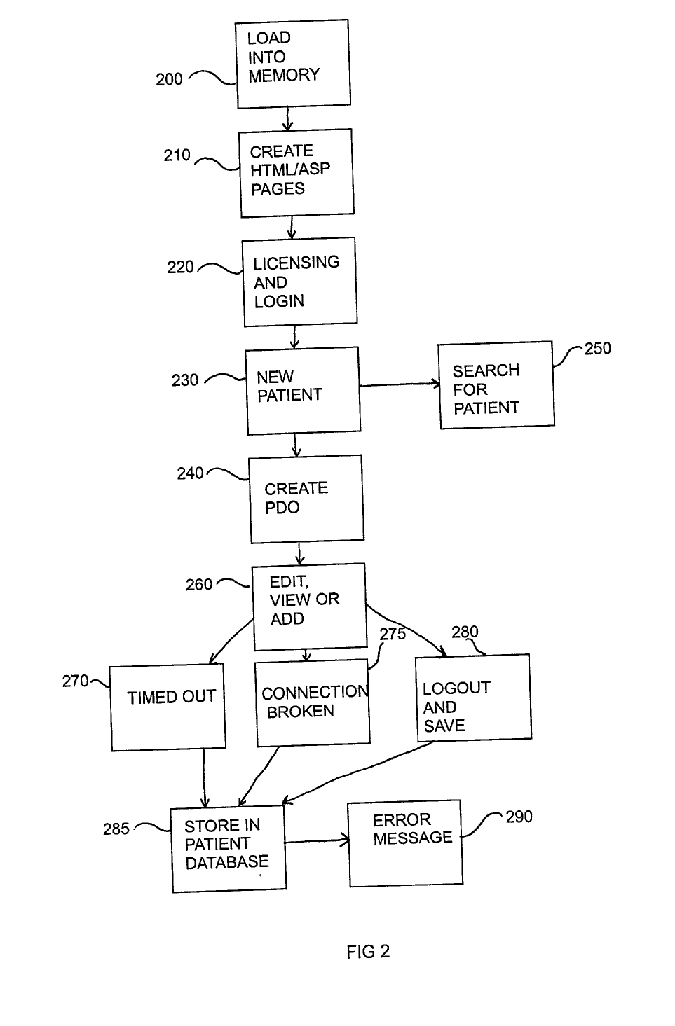

FIG. 2 is flow chart illustrating an embodiment of the present invention where configuration module 150 loads the configuration into memory from configuration database 155 (operation 200), calls up generator 130 to create the HTML/ASP page documents (operation 210), licensing and login of a user is checked (operation 220), it is determined whether the user is entering a new patient (operation 230), if yes, patient data object 160 is created for a new patient (operation 240), and if no, a search using searching module 170 is performed and previously stored information is loaded into newly created patient data object 160 (operation 250). Thereafter, the user may view, edit, or add additional data to the HTML/ASP page documents (operation 260). It is then determined whether patient data object 160 has timed out (operation 270), whether the connection between user system 100 and patient evaluation unit 120 has been broken (operation 275), or whether a log out and save has been initiated (operation 280). If any of operations 270, 275, or 280 determinations are yes then the data stored in patient data object 160 is stored in patient database 180 if there is sufficient identifying data (operation 285). If there is not sufficient identifying data then an error message may be relayed to the user, if still available, that insufficient identifying data has been entered (operation 290). The user will also be given the opportunity to cancel a session, at which time the patient data object may be dumped and all information therein lost.

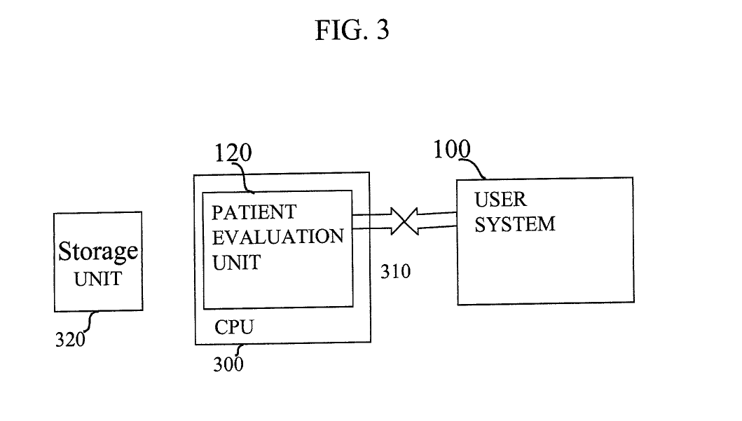

FIG. 3 illustrates an embodiment of the present invention where user system 100 may be connected to patient evaluation unit 120 by a transmission channel 310, with transmission channel 310 being potentially a land-line, including optical, telephone, cable, or any Internet or Intranet access line, without being limited thereto, or a wireless channel based on any number of wireless standards. Further, the present invention includes the reception of a transmission by user system 100 including data generated by patient evaluation unit 120. Also, as illustrated in FIG. 3, software for implementing patient evaluation unit 120 may be stored on a recordable medium and read by storage unit 320 attached to a CPU 300, with the patient evaluation software being loaded into the memory of CPU 300 and thereby controlling CPU 300 to perform the present invention, with that recordable medium being potentially a hard disk, a magnetic disc, or any optical readable disc, without being limited thereto.

As set forth above, the present invention includes a patient evaluation system allowing for individualized patient evaluation configurations, a centralized hierarchy so large computer resources are not necessary at a users end, for allowing authorized users to enter new patient data, edit and view existing patient data, and for allowing searching for patient data within available databases. In addition, the patient evaluation system can be easily updated with new forms by merely updating configuration database 155. As set forth in one embodiment, configuration module 150 may frequently check whether configuration database 155 has been updated, and thus may automatically cause updated HTML/ASP page documents to be created by generator 130.

Thus, although a few preferred embodiments of the present invention have been shown and described, it would be appreciated by those skilled in the art that changes may be made in these embodiments without departing from the principles and spirit of the invention, the scope of which is defined in the claims and their embodiments.

What is claimed is:

1. A patient evaluation apparatus, comprising:
a configuration module including a configuration database of form data for a medical evaluation form;
a dynamic generator to create a marked up document based upon the form data; and
a transmitting module to combine the marked up document with medical data of a patient and transmitting the combined marked up document through a transmission channel, such that a user having a browser is capable of receiving and displaying the combined marked up document.

2. The patient evaluation apparatus of claim 1, further comprising a patient data object to store the medical data, the medical data being entered by the user in the received combined marked up document.

3. The patient evaluation apparatus of claim 2, wherein the patient evaluation apparatus performs a search for the medical data in a patient database and stores found patient's records in the patient data object.

4. The patient evaluation apparatus of claim 3, wherein the user may alter medical data stored in the patient data object by entering different medical data over the medical data combined in the combined received marked up document.

5. The patient evaluation apparatus of claim 1, wherein the configuration module checks the configuration database to determine whether the configuration database has changed, and upon a change of the configuration database the configuration module causes the dynamic generator to re-create the marked up document.

6. The patient evaluation apparatus of claim 1, wherein the transmission channel is an Internet or Intranet channel and the marked up document is a HTML/ASP document.

7. The patient evaluation apparatus of claim 1, further comprising:
an authorization module to determine whether the user is permitted to view a received combined marked up document.

8. A patient evaluation method, comprising:
dynamically creating a marked up document based on a configuration database, with the configuration database including form data for medical evaluation forms;
combining the marked up document with medical data of a patient; and
transmitting the combined marked up document through a transmission channel to a user having a browser capable of receiving and displaying the received marked up document.

9. The patient evaluation method of claim 8, further comprising monitoring for a user alteration of the medical data in the received marked up document.

10. The patient evaluation method of claim 9, wherein the user altered medical data is caused to replace the medical data in a patient database that stored the medical data.

11. The patient evaluation method of claim 8, further comprising storing a user alteration of the medical data in the received marked up document and storing the alteration of medical data in a patient database if it is determined that a break in the transmission channel to the user has occurred.

12. The patient evaluation method of claim 8, further comprising storing a user alteration of the medical data in the received marked up document, and upon an end of session request by the user the altered medical data is caused to replace the medical data in a patient database that stored the medical data.

13. The patient evaluation method of claim 8, further comprising storing a user alteration of the medical data in the received marked up document, and upon a cancel request by the user the altered medical data is deleted.

14. A patient evaluation method, comprising:
dynamically creating a marked up document based on a configuration database, with the configuration database including form data for medical evaluation forms;
transmitting the marked up document through a transmission channel to a user having a browser capable of receiving and displaying the received marked up document;
monitoring for a user addition of medical data to the received marked up document;
storing the medical data; and
transmitting a combination of the stored medical data and the marked up document through the transmission channel to the user.

15. The patient evaluation method of claim 14, wherein the stored medical data is stored in a patient database upon a determination that the medical data is sufficiently unique to identify a patient corresponding to the stored medical data.

16. The patient evaluation method of claim 15, wherein if the medical data is not sufficiently unique then sending an error message to the user indicating that additional medical data is necessary.

17. The patient evaluation method of claim 14, further comprising determining whether the user is authorized to receive the marked up document.

18. The patient evaluation method of claim 14, wherein the transmission channel is an Internet or Intranet channel and the marked up document is a HTML/ASP document.

19. A readable medium, for use in a computational device, comprising a program causing the computational device to:
dynamically create a marked up document based on a configuration database, with the configuration database including form data for medical evaluation forms;
combine the marked up document with medical data of a patient; and
transmit the combined marked up document through a transmission channel to a user having a browser capable of receiving and displaying the received marked up document.

20. The readable medium of claim 19, wherein the program further causes the computational device to monitor for a user alteration of the medical data in the received marked up document.

21. The readable medium of claim 20, wherein the program further causes the computational device to cause the user altered medical data to replace the medical data in a patient database that stored the medical data.

22. The readable medium of claim 19, wherein the program further causes the computational device to store a user alteration of the medical data in the received marked up document and store the alteration of medical data in a patient database if it is determined that a break in the transmission channel to the user has occurred.

23. The readable medium of claim 19, wherein the program further causes the computational device to store a user alteration of the medical data in the received marked up document, and upon an end of session request by the user the altered medical data is caused to replace the medical data in a patient database that stored the medical data.

24. The patient evaluation method of claim 19, wherein the program further causes the computational device to store a user alteration of the medical data in the received marked up document, and upon a cancel request by the user the altered medical data is deleted.

25. A readable medium, for use in a computational device, comprising a program causing the computational device to:
dynamically create a marked up document based on a configuration database, with the configuration database including form data for medical evaluation forms;
transmit the marked up document through a transmission channel to a user having a browser capable of receiving and displaying the received marked up document;
monitor for a user addition of medical data to the received marked up document;
store the medical data; and
transmit a combination of the stored medical data and the marked up document through the transmission channel to the user.

26. The readable medium of claim 25, wherein the program further causes the computational device to store the stored medical data in a patient database upon a determination that the medical data is sufficiently unique to identify a patient corresponding to the stored medical data.

27. The readable medium of claim 26, wherein if the medical data is not sufficiently unique then an error message is sent to the user indicating that additional medical data is necessary.

28. The readable medium of claim 25, wherein the program further causes the computational device to determine whether the user is authorized to receive the marked up document.

29. The readable medium of claim 25, wherein the transmission channel is an Internet or Intranet channel and the marked up document is a HTML/ASP document.
